(19) United States
(12) Patent Application Publication
(10) Pub. No.: US 2010/0203920 A1
(43) Pub. Date: Aug. 12, 2010

(54) PERSONAL COMMUNICATION DEVICE WITH INTEGRATED ALARM

(76) Inventor: Ted Walter Gregory, Flagler Beach, FL (US)

Correspondence Address: Daniel Law Offices, 37 N. Orange Ave., Suite 500, Orlando, FL, 32801, US

(21) Appl. No.: 12/694,907

(22) Filed: Jan. 27, 2010

Related U.S. Application Data
(60) Provisional application No. 61/206,937, filed on Feb. 6, 2009.

(51) Int. Cl. H04M 1/00; G08B 1/08

(52) U.S. Cl. 455/556.1; 340/539.13

(57) ABSTRACT

An improved personal communication device that incorporates a physical security alarm can include a communication unit for performing wireless communication across a network, one or more sensors configured to detect movement, and an alarm which activates in response to detection by the one or more sensors. One or more sensors can include a directional motion detector and a multidirectional proximity sensor. The improved personal communication device can also include a voice response unit configured to activate the alarm in response to a predetermined voice command.

### CROSS-REFERENCE TO RELATED APPLICATIONS

This application claims the benefit of U.S. provisional Patent Application No. 61/206,937 filed on Feb. 6, 2009, the entire contents of which are hereby incorporated by reference.

### BACKGROUND

1. Field of the Invention

The present invention relates generally to an improved personal communication device, such as a cellular telephone, that incorporates a physical security alarm.

2. Description of the Related Art

Owing to the ever increasing crime rates in this and other countries, the market for personal safety devices has grown substantially in recent years. As such, there are numerous personal safety devices available to concerned citizens ranging from alarms such as whistles and push button panic devices, to non-lethal weapons such as pepper spray and stun guns. However, these devices have the distinct disadvantage of only being able to protect a user that is already under attack. Moreover, as these devices are rarely used, it is common for a user to misplace or fail to wear the device at all times.

Accordingly, it would be beneficial to incorporate a physical security alarm into a personal communication device commonly carried by a user, such as a cellular telephone or a personal data assistant. Additionally, it would also be beneficial for the physical security alarm to provide proactive security, such as providing a warning to a user of an impending attack.

### SUMMARY OF THE INVENTION

The present invention is directed to an improved personal communication device that incorporates a physical security alarm. One embodiment of the present invention can include a communication unit for performing wireless communication across a network, one or more sensors configured to detect movement, and an alarm which activates in response to detection by the one or more sensors. Another embodiment of the present invention can include a communications unit in which the one or more sensors can be a directional motion detector and a multidirectional proximity sensor. Yet another embodiment of the present invention can include a voice response unit configured to activate the alarm in response to a predetermined voice command.

### BRIEF DESCRIPTION OF THE DRAWINGS

Presently preferred embodiments are shown in the drawing(s). It should be appreciated, however, that the invention is not limited to the precise arrangements and instrumentalities shown.

FIG. 1 illustrates one embodiment of a personal communication device that is useful for understanding the embodiments disclosed herein.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As will be appreciated by one skilled in the art, aspects of the present invention may be embodied as a system, method or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

As used herein, a Personal Communication Device (PCD) can include any known device capable of performing wireless communication including, but not limited to a cellular telephone, wireless telephone, personal data assistant, laptop, two way pager or computer, for example.

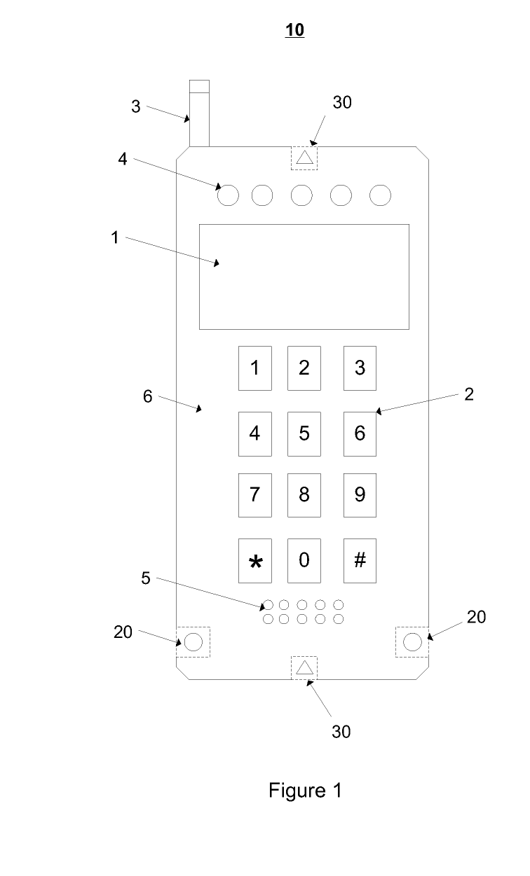

FIG. 1 illustrates one embodiment of a personal communication device that is useful for understanding the embodiments disclosed herein. As illustrated, PCD 10 can include a cellular telephone comprising known elements such as a display 1, push buttons 2, cellular antenna 3, speaker 4, microphone 5, and internal electronics 6.

According to one embodiment, PCD 10 can further include one or more miniature directional motion detection sensors 20, such as, for example, a passive infrared detector. Motion detectors of this type are known in the art, as are the corresponding circuitry. As such, according to a preferred embodiment, the passive motion detector 20 can be included in the manufacture of the PCD thus allowing the necessary circuit connections for the motion detector to be included into the PCD internal electronics 6. As used herein, necessary circuitry can include a hard wire or wireless connection to the internal electronics 6.

Although illustrated with respect to a passive infrared detector located on the sides of the PCD, other placement locations and other known motion sensors having low power requirements while in the detection mode are also contemplated.

The PCD 10 incorporating motion sensor 20, according to one embodiment can detect unauthorized movement in a designated area and provide a warning notification to a user. In operation, PCD 10 can be placed at a position in which at least one of the motion sensors 20 are facing a vulnerable location, such as a door or window, for example. Upon placing the device in the desired location, the motion sensor can be activated and, upon detecting movement, the motion sensor 20 can immediately activate an alarm feature of the PCD 10.

As used herein, activating an alarm feature can include providing an audio and/or visual notification to the user via the speaker 4 and/or the display 1 of the PCD. Moreover, the PCD 10 can further provide emergency notification to external individuals such as a designated (or local) law enforcement agency, a central alarm monitoring agency, or a user defined emergency contact that is programmed into the memory of the PCD 10. Additionally, if the personal communications device includes a GPS unit, the PCD can be preprogrammed to also send the exact location of the device when transmitting the emergency notification.

As would be known to one of skill in the art, the emergency notification can be communicated via voice or data and locations at which the security features of the PCD can be utilized are virtually limitless. In this manner, the PCD 10 can provide an immediate notification to a user that a threat is approaching, thus giving the user time to respond while simultaneously and automatically requesting emergency assistance.

In an another embodiment, PCD 10 can further include one or more multidirectional proximity sensors 30. Sensor 30 can be utilized in combination with or apart from the motion detector 20 described above. As such, sensor 30 can include, for example, an infrared or electro-magnetic field type sensor which are known in the art, although other types of proximity sensors are also contemplated. As with the motion detector 20, the one or more proximity sensor 30 according to a preferred embodiment can be included in the manufacture of the PCD thus allowing the necessary circuit connections (also known) for the proximity sensor 30 to be included into the internal electronics 6 of the PCD 10. As used herein, necessary circuit connections can include a hard wire or wireless connection to the internal electronics 6.

In operation, the proximity sensor 30 of the PCD 10 according to one embodiment can detect unauthorized movement and provide a warning notification to a user. To this end, the proximity sensor 30 can provide multidirectional sensing functionality capable of detecting objects moving anywhere within the sensing field of the sensor 30, thus eliminating the need to aim the PCD 10.

For example, in one embodiment, a user can set the PCD on the floor and activate the one or more sensors 30. Once activated, the sensing field of the device, operating in a known manner, can include a coverage area that will approximate a hemisphere with the PCD located at its center. As such, the PCD 10 according to this embodiment can be placed virtually anywhere and once armed, movement from any direction will activate the alarm. As would be know to one of skill in the art, the sensing field of a proximity sensor depends entirely upon the design and power of the specific sensor utilized. In either case, however, each sensor 30 will typically have a sensing field ranging from a few inches to several meters or more.

In another embodiment, PCD 10 can further include a voice activated alarm function. Voice activated calling, and the associated components necessary to perform the same are known to those of skill in the art, however, the PCD 10 utilizes this function in a novel way. In one embodiment, a user of the PCD 10 including a voice activated alarm function can pre-program an emergency code word into the PCD. Then, in a threat situation, when the user speaks the code word, the device can automatically activate the alarm.

Although the above preferred embodiments describe a device with detection sensors incorporated into the body of the PCD, other embodiments are also contemplated. For instance, one or more motion detection sensors 20, and/or proximity sensors 30 can also be configured to operate in conjunction with an existing PCD. To this end, in one embodiment, motion detection sensors 20 and proximity sensors 30 can be self contained modules capable of attaching to an existing PCD (i.e. via a clip or other known attachment means) and can communicate directly with the PCD via known wire or wireless methods. As such, by providing sensor modules that can be removably attached to an existing PCD, the inventive concepts disclosed herein can be carried out utilizing existing communication devices.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A communication device and integrated personal security alarm comprising:
a communication unit configured to communicate wirelessly across a communications network;
one or more sensors configured to detect movement; and
an alarm configured to activate in response to detection by the one or more sensors.

2. The communication device and integrated personal security alarm of claim 1, wherein said one or more sensors includes a directional motion detector.

3. The communication device and integrated personal security alarm of claim 2, wherein said directional motion detector includes a passive infrared detector.

4. The communication device and integrated personal security alarm of claim 1, wherein said one or more sensors includes a multidirectional proximity sensor.

5. The communication device and integrated personal security alarm of claim 4, wherein said multidirectional proximity sensor includes one of a infrared field type sensor and an electro-magnetic field type sensor.

6. The communication device and integrated personal security alarm of claim 1, further comprising:
a voice response unit configured to activate the alarm in response to a predetermined voice command.

7. The communication device and integrated personal security alarm of claim 1, wherein said communications unit includes one of a cellular telephone, wireless telephone, pager and personal data assistant.

8. The communication device and integrated personal security alarm of claim 1, wherein said communication unit is further configured to transmit an automatic message upon activation of the alarm.

9. The communication device and integrated personal security alarm of claim 1, further comprising at least one of:
a speaker configured to audibly alert a user;
a display configured to visually alert a user; and
a global positioning system (GPS) locator configured to report a position of the device.

10. The communication device and integrated personal security alarm of claim 9, wherein said alarm is further configured to activate at least one of said speaker and display.

11. The communication device and integrated personal security alarm of claim 9, wherein said communication unit is further configured to transmit the position of the device upon activation of the alarm.

12. The communication device and integrated personal security alarm of claim 1, wherein said one or more sensors are removably attached to the communication device.

13. A communication device and integrated personal security alarm comprising:
means for communicating wirelessly across a network;
means for detecting movement; and
an alarm configured to activate in response to the means for detecting.

14. The communication device and integrated personal security alarm of claim 13, wherein said means for detecting movement is removably attached to the communication device.
